(19) United States
(12) Patent Application Publication
(10) Pub. No.: US 2020/0090856 A1
(43) Pub. Date: Mar. 19, 2020

(54) THIN TRANSFORMER AND METHOD OF PRODUCTION OF SAME

(71) Applicant: Thin Energy LTD., Lod (IL)

(72) Inventors: Daniel ASSIS, Elqana (IL); Itay HASID, Tel Aviv (IL); Ilya NEMENMAN, Modi'in-Maccabim-Re'ut (IL)

(73) Assignee: Thin Energy LTD., Lod (IL)

(21) Appl. No.: 16/618,201

(22) PCT Filed: May 29, 2018
(86) PCT No.: PCT/IL2018/050585

§ 371 Date: Nov. 29, 2019

Related U.S. Application Data
(60) Provisional application No. 62/512,087, filed on May 29, 2017.

(51) Int. Cl. H01F 27/28; H01F 27/30; H01F 41/12; H01F 27/32

(52) U.S. Cl. CPC H01F 27/2823; H01F 27/2871; H01F 27/323; H01F 41/122; H01F 27/306

(57) ABSTRACT

An ultra-thin transformer (UTT) is disclosed. The UTT is comprised of an ultra-thin core (UTC), which comprises a base unit comprising a central core branch, at least one side branch, a plurality of dents forming a toroidic space in the base unit around the central core branch, and an open face. The UTC also comprises a cover unit adapted to match the open face of the base unit. The UTT also comprises a primary winding and a secondary winding. A method for production of thin helical winding is also disclosed. The method comprises obtaining a wire adapted to form a helical layer, winding the wire of certain transformer's layer between two flat plates, and removing the flat plates when the layer is finished.

### BACKGROUND OF THE INVENTION

Power supplier and battery chargers are widely used. Many of them are designed to be fed from home power grid, ranging for example between 110 VAC to 220 VAC. Charger and power supplier that are fed from home power grid and designed to supply output DC voltage ranging between, for example, 20 VDC and 5 VDC. Such voltage step-down is dealt with typically using at least one stage of step-down transformer.

Transformers convert electrical AC current in a primary winding to magnetic flux which is then converted back to electrical AC current in a secondary winding of the transformer. The voltage ratio between the input voltage at the terminals of the primary winding and the output voltage at the terminals of the secondary winding is directly proportional to the ration between the number of windings N1 of the primary to the number of windings N2 of the secondary. Thus, a step-down transformer will have N1/N2>1.

In order to efficiently transform the electrical energy by a transformer, the electrical resistance of the windings should be kept as low as possible, and the resistance to the magnetic flux should also be kept as low as possible. Both types of resistances will be decreased as the cross section of the respective conduit, electrical wires and magnetic core, respectively, will grow bigger, irrespective of the material they are made of. This basic physical rule dictates that a given amount of power that needs to be transferred limits the ability to decrease the size, or volume of the transformer. On the other hand, users of many portable electronic devices, such as cellular phones and smartphones, portable computing devices (laptop computers, tablets, and the like) rely on availability of a handy power charger, and for the sake of comfort and appearance, would prefer the charger to be as small as possible, preferably as small as a credit card with thickness no bigger than twice or three times the thickness of the credit card, which would make that charger almost unnoticeable.

There is a need to provide very thin transformers for use in super thin chargers and power suppliers.

### SUMMARY OF THE INVENTION

An ultra-thin transformer (UTT) is presented comprising an ultra-thin magnetic core (UTC) that comprises a base unit, a cover unit, a primary winding and a secondary winding. The base unit comprising a central core branch, at least one side branch, a plurality of dents forming a toroidic space in the base unit around the central core branch and an open face.

In some embodiments, the UTT comprises a windings toroid adapted to substantially cover the primary winding and the secondary winding.

In some embodiments, the primary winding further comprises two layers of windings disposed at opposite ends, wherein the secondary winding is disposed in at least one layer between the two primary winding's layers, each of the winding layers comprises a flat helical continuous wire. In further embodiments, the primary winding's layers are made of an electrical wire having a triple insulation adapted to conform with high voltage insulation requirements. In still further embodiments, the primary winding's layers conform with the standard defined by IEC/UL 60950.

In some embodiments the, UTT comprises four side branches forming a substantially rectangular prism-shaped UTC, wherein at least one of the primary winding and the secondary winding may protrude from four faces of the UTC.

In some embodiments, the UTT comprises three side branches forming a substantially triangular prism-shaped UTC, wherein at least one of the primary winding and the secondary winding may protrude from three faces of the UTC.

In some embodiments, the UTC is substantially cylindrical, wherein the toroidic space and the UTC have a common axis of symmetry.

In some embodiments, the UTC is made of a magnetic permeable material.

In some embodiments, the UTT is operable in operation frequencies in the range of 50 kHz-5 MHz.

In some embodiments, the maximal thickness of the UTT is 3.95 mm, wherein the maximal thickness of the base unit's face is 1.1 mm, wherein the maximal thickness of the cover unit is 1.1 mm, leaving space of at least 1.75 mm for the primary winding and the secondary winding.

A method for production of thin helical winding is also disclosed. The method comprises obtaining a wire adapted to form a helical layer, winding the wire of certain transformer's layer between two flat plates and removing the flat plates when the layer is finished.

In some embodiments, the helical layer is made of a wire having diameter of 0.42 mm or less.

In some embodiments, the wire is coated with very thin polymeric coating, wherein the coating's melting point is lower than that of the wire insulating coating.

The method for the production of a thin transformer further comprising, after the step of winding the wire, heating the coating to its melting point temperature, thereby melting the coating and stopping the heating after a pre-determined heating time, allowing the coil to cool down, thereby to solidify the coil.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are schematic illustrations of configurations of transformers of the prior art;

FIG. 1C is a schematic isometric illustration of a transformer core, including arrows that indicate the magnetic flux according to the configuration of FIG. 1B;

FIG. 2A is a schematic isometric illustration of an ultra-thin transformer according to embodiments of the present invention;

FIG. 2B is a schematic three-dimensional (3D) blown illustration of the thin transformer of FIG. 2A, according to embodiments of the present invention;

FIG. 2C is a cross section view of the thin transformer of FIG. 2A;

FIG. 2D is a schematic cross section view of transformer windings, showing the primary winding's layers and the secondary winding's layer in between, according to embodiments of the present invention;

FIG. 3A schematically depicts three helical windings in a blown view, according to embodiments of the present invention; and

FIG. 3B is a schematic illustration of a method for producing very thin helical winding using a flat plate, according to embodiments of the present invention.

It will be appreciated that for simplicity and clarity of illustration, elements shown in the figures have not necessarily been drawn to scale. For example, the dimensions of some of the elements may be exaggerated, relative to other elements, for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

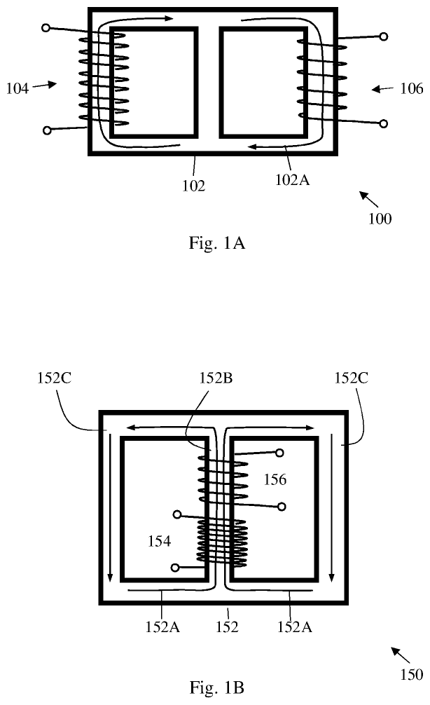

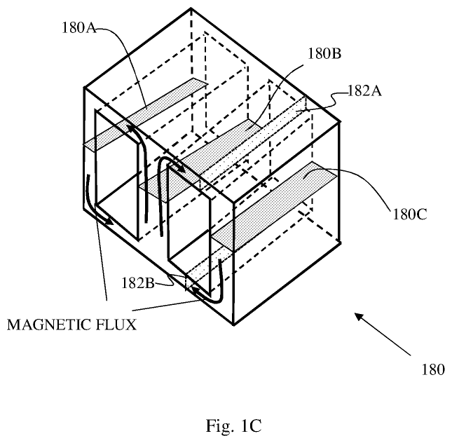

Reference is made now to FIGS. 1A and 1B, which are schematic illustrations of configurations 100 and 150, respectively, of transformers as known in the prior art. Transformer configuration 100 depicts embodiment in which the magnetic core 102 comprises two adjacent magnetic loops and the windings of the primary 104 and the secondary 106 windings are located on the outer branches of the core 102. As a result, the main magnetic flux flows through the external path 102A while the middle path is substantially not in use for flowing magnetic flux. FIG. 1B depicts a schematic illustration of transformer configuration 150 in which the shape of the magnetic core is similar to that of transformer 100, but both the primary and the secondary windings 154, 156, are wound around the central branch of the magnetic core 152. As a result, the magnetic flux flows through all branches of the magnetic core 152, as depicted by arrows 152A. In this configuration, the total cross section of magnetic core available for the magnetic flux is higher than that of configuration 100, thereby enabling transforming of higher power with lower magnetic resistance of the core.

Reference is made now to FIG. 1C, which is a schematic isometric illustration of a transformer core 180. For transformer windings configuration as in FIG. 1B, the magnetic flux would flow as depicted by the arrows of FIG. 1C. The cross section available for the magnetic flux flowing in the vertical branches is depicted by the cross section-like grey areas 180A, 180B and 180C. The cross section available for the magnetic flux flowing in the horizontal branches is depicted by the cross section-like grey areas 182A, 182B. Any attempt to reduce the physical dimensions of the transformer is deemed to affect the cross section available for the magnetic flux flow, which in turn will limit the amount of electrical power that may be transformed via the transformer.

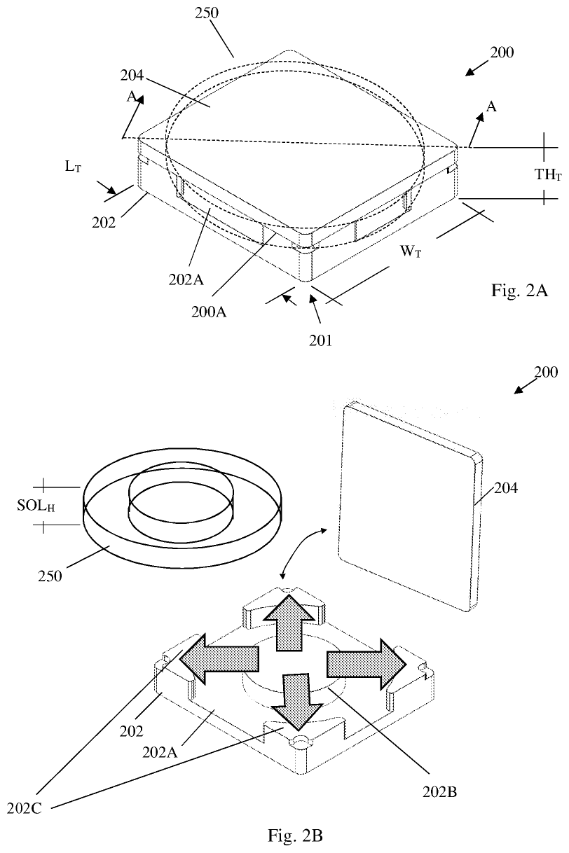

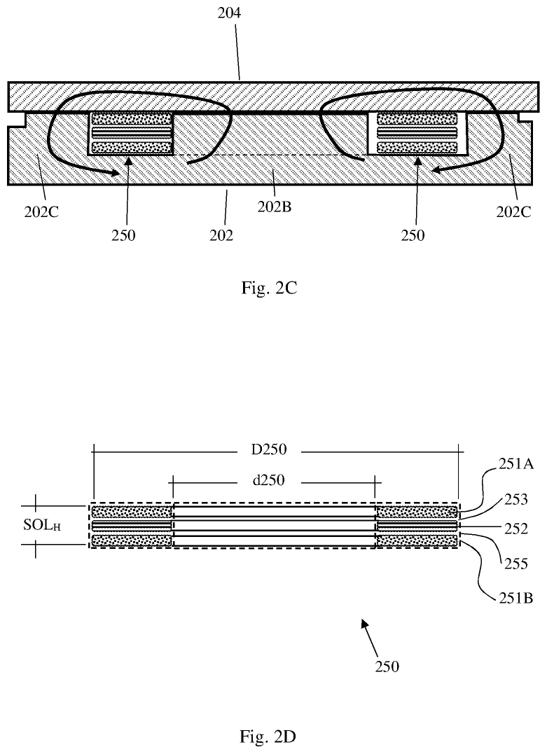

Reference is made to FIG. 2A which is a schematic isometric illustration of an ultra-thin transformer 200, according to embodiments of the present invention. Ultra-thin transformer (UTT) 200 comprises an ultra-thin core (UTC) 201 comprising base unit 202 and cover unit 204, adapted to match the open face of base unit 202. UTC 201 may be made of magnetic permeable material that may be selected to have the magnetic parameters (such as magnetic field [H], magnetic flux density [B], core losses, operating frequency, permeability, and the like) that meet the overall design requirements of the transformer. For example—operability in operation frequencies in the range of 50 kHz-5 MHz, etc. UTC 201 is formed to accommodate windings toroid 250 that may be utilized to host primary and secondary windings of UTT 200, with turns ratio as required and high voltage in-to-out isolation as required.

Reference is made now also to FIG. 2B which is a schematic three-dimensional (3D) blown illustration of ultra-thin transformer 200 of FIG. 2A, according to embodiments of the present invention. As shown in FIG. 2B, base unit 202 comprises a plurality of dents, or engraving, 202A forming toroidic space in base unit 202 formed around central core branch 202B. Cover unit 204 is made to fit onto and fully cover base unit 202, thereby completing a four-way magnetic path around core branch 202B and via four side branches 202C (as depicted by the grey arrows). As shown in FIG. 2B, at least one of the primary winding and the secondary winding may protrude from four faces of the UTC. However, the rectangular prism-shaped UTC of FIG. 2B is just a non-limiting example, whereas triangular prism-shaped UTCs (in which at least one of the primary winding and the secondary winding may protrude from three faces of the UTC) and substantially cylindrical UTCs (in which the toroidic space and the UTC have a common axis of symmetry) are possible as well. The hollow space defined between base unit 202 and cover unit 204 is depicted by toroid or a toroidic space 250, which schematically defines the volume available for the transformer's windings (toroid windings).

Reference is now made to FIG. 2C, which is a schematic cross section view of UTT 200 along cross section line AA in FIG. 2A. As can be seen in FIG. 2C, base unit 202 is covered by cover unit 204. The core 201 formed by base unit 202 and cover unit 204 forms magnetic flux paths, inter alia, as depicted by the arrows running through central core branch 202B and via side core branches 202C. The magnetic flux surrounds winding volume 250 which is adapted to accommodate the transformer's primary and secondary windings. In some embodiments of the present invention, the thickness TH_{T} of the transformer may be no more than 3.95 mm (maximal thickness), the thickness of the base unit basis TH_{B} may be no more than 1.1 mm and the thickness TH_{C} of the cover unit may be no more than 1.1 mm, leaving at least 1.75 mm for the windings of the transformer (SOL_{H}).

Reference is now made to FIG. 2D, which is a schematic cross section view of the primary windings 251A, 251B and of the secondary winding 252, according to embodiments of the present invention. The primary winding may be embodied using two layers of windings, disposed at the external opposite ends of transformer's winding 250. The secondary winding may be embodied in one or more adjacent layers disposed between the primary windings layers. Each of the windings layers may comprise a flat helical continuous wire, as explained in details below.

The primary winding layers may be made of electrical wire having triple insulation, to conform with high voltage insulation requirements, such as UL 60950. Typically, but not limited to, the number of turns of the primary will be higher than that of the secondary, to provide voltage step-down transformation. In other embodiments, the transformer may be designed for voltage step-up function or simply for galvanic isolation with, for example 1:n transformation ratio.

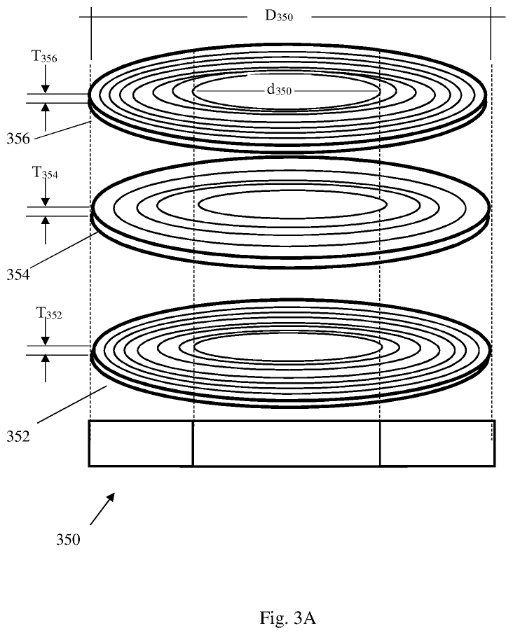

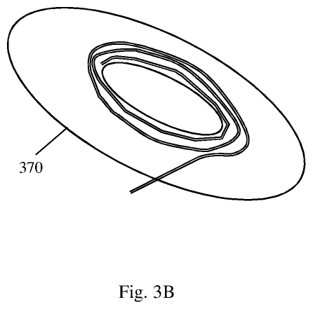

The production of the transformer stage with the higher number of turns may raise some production difficulties, for example when producing the flat helical layer with a wire having diameter of 0.42 mm or less. It may be convenient to wound the helical winding of a certain transformer layer between two flat plates and remove the plates when the winding is finished. See one such support plate 370 in FIG. 3B, which is a schematic illustration of a method for producing very thin helical winding. Yet, due to the small size/diameter of the wire and its low stiffness figure, when the support plates are removed the helical coil may collapse. According to some embodiments, the winding of such small size helical coil may be carried out using electrical wires coated, around the insulation layer, with very thin polymeric coating. The coating may have melting point CT_{M} (° C.) lower than that of the wire insulating coating. When the preparation of the helical coil between the support plates terminates, the coil may be heated to the CT_{M} temperature thereby melting the polymeric coating. After a pre-determined heating time the heating may be stopped allowing the coil to cool down and the polymeric coating to solidify, thereby to solidify the coil. The heating may be carried out using any known means and methods, such as direct heating (e.g., hot air), induction heating, ultrasonic heating, and the like. The support plates may be selected from material that has low tendency to solidify with the polymeric material, to ease the separation of the plates after the polymeric costing has solidified. The windings of the primary stage may be embodied by performing a helical winding layer running from the outer perimeter inbound, crossing next to the navel (or center) of the transformer from an external primary winding layer to the external primary layer on the other side of the transformer and being wound from the inner perimeter outbound thereby creating a single winding of the primary stage embodied in two layers formed at two opposing external layers.

Between the helical coils layers, insulation layers 253, 255 may be placed if needed. However, when low thickness is a goal of design and the regulation does not require such insulation, such insulation layers may be avoided.

Reference is made now to FIG. 3A which schematically depicts three helical windings 352, 354 and 356 in a blown view, according to embodiments of the present invention. Each of the helical windings may have external diameter D350, internal diameter d350 and helical coil thickness T352, T354 and T356, respectively. The thickness of the coils may be selected to optimally utilize the available coils volume while considering the currents flowing in each of the coils, to arrive at an optimal utilization of the volume, or—to arrive at a minimal transformer thickness for a given available width and length and required transformation power. The UTT may further comprise two input terminals and two output terminals, wherein the input terminals may be connected to the primary winding and the output terminals may be connected to the secondary winding. According to some embodiments, in order to enable high number of windings of the secondary coil, two layers or more of coils may be connected electrically in series. For example, coils 352 and 356 may be connected in series, and the direction of turns is set to provide unified magnetic flux in the same direction. The connection may be carried out by a via connector (not shown in the drawing), which may be embodied with the same insulation requirements applied to the windings. According to some embodiments, the diameter of the wire of the secondary winding may be changed along the helical winding in order to ensure that each of the turns has the same internal resistance per full turn, i.e., the diameter of the external windings may be larger than that of internal winding in order to compensate for longer winding length. In other embodiments, the change in external resistance may be achieved in other ways, such as change in the purity of the wire material along the winding. In some embodiments, the winding of the secondary stage may be of a wire that has same diameter along the entire winding.

According to some embodiments, in order to achieve very low impedance of the secondary stage, secondary terminals of two or more transformers may be connected in parallel.

According to some embodiments the terminals of the secondary windings may be positioned rotated in 90 degrees with respect to the orientation of the terminals of the primary windings, in order to optimize the utilization of the volume around the windings and allow for better minimization of the transformer.

The ferromagnetic material(s) for the production of the transformer core may be selected according to considerations such as work frequency, required/limitation of power losses, energy storage capability, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An ultra-thin transformer (UTT), the UTT comprising:
an ultra-thin magnetic core (UTC), the UTC comprising:
a base unit comprising:
a central core branch;
at least one side branch;
a plurality of dents forming a toroidic space in the base unit around the central core branch; and
an open face;
a cover unit adapted to match the open face of the base unit;
a primary winding; and
a secondary winding.

2. The UTT of claim 1, wherein the primary winding further comprises two layers of windings disposed at opposite ends, wherein the secondary winding is disposed in at least one layer between the two primary winding's layers, each of the winding layers comprises a flat helical continuous wire.

3. The UTT of claim 2, wherein a first primary winding's layer is a helical winding layer that is wound from the UTC's perimeter inbound, crossing next to the center of the UTT from the first primary winding's layer to a second primary winding's layer positioned opposite to the side of the first primary winding's layer, wherein the second primary winding's layer is wound from the UTC's perimeter outbound, thereby creating a single winding of the primary winding via two opposing layers.

4. The UTT of claim 3, wherein the primary winding's layers are made of an electrical wire having a triple insulation adapted to conform with high voltage insulation requirements.

5. The UTT of claim 1 further comprising a windings toroid adapted to substantially cover the primary winding and the secondary winding

6. The UTT of claim 1 comprising four side branches forming a substantially rectangular prism-shaped UTC, wherein at least one of the primary winding and the secondary winding may protrude from four faces of the UTC.

7. The UTT of claim 1 comprising three side branches forming a substantially triangular prism-shaped UTC, wherein at least one of the primary winding and the secondary winding may protrude from three faces of the UTC.

8. The UTT of claim 1, wherein the UTC is substantially cylindrical, wherein the toroidic space and the UTC have a common axis of symmetry.

9. The UTT of claim 1, wherein the UTC is made of a magnetic permeable material.

10. The UTT of claim 1, wherein it is operable in operation frequencies in the range of 50 kHz-5 MHz.

11. The UTT of claim 1, wherein the maximal thickness of the UTT is 3.95 mm, wherein the maximal thickness of the base unit's face is 1.1 mm, wherein the maximal thickness of the cover unit is 1.1 mm, leaving space of at least 1.75 mm for the primary winding and the secondary winding.

12. The UTT of claim 1 further comprising:
two input terminals; and
two output terminals,
wherein the input terminals may be connected to the primary winding and the output terminals may be connected to the secondary winding.

13. The UTT of claim 1, wherein the UTT is adapted to connect to at least one selected from the group comprising of a power supplier, a battery charger, a thin battery, a laptop, and to a smartphone.

14. The UTT of claim 1, wherein the UTT is utilized as a step-down transformer.

15. The UTT of claim 1, wherein the UTT is utilized as a step-up transformer.

16. The UTT of claim 1, wherein the UTT is used for galvanic isolation.

17. The UTT of claim 1, wherein the transformation ratio is 1:n.

18. A method for production of thin helical winding, the method comprising:
obtaining a wire adapted to form a helical layer;
winding the wire of certain transformer's layer between two flat plates; and
removing the flat plates when the layer is finished.

19. The method of claim 18, wherein the helical layer is made of a wire having diameter of 0.42 mm or less.

20. The method of claim 18, wherein the wire is coated with very thin polymeric coating, wherein the coating's melting point is lower than that of the wire insulating coating.

21.-29. (canceled)
